(19) United States
(12) Patent Application Publication
(10) Pub. No.: US 2006/0036990 A1
(43) Pub. Date: Feb. 16, 2006

(54) Tool comprising systems engineering environment for meeting task requirements

(75) Inventor: Leonard Karas, Owego, NY (US)

Correspondence Address: Steven W. Weinrieb;SCHWARTZ & WEINRIEB, Crystal Plaza One, Suite 1109, 2001 Jefferson Davis Highway, Arlington, VA, 22202, US

(73) Assignee: LOCKHEED MARTIN CORPORATION

(21) Appl. No.: 10/918,424

(22) Filed: Aug. 16, 2004

(51) Int. Cl. G06F 9/44

(52) U.S. Cl. 717/101

(57) ABSTRACT

A new and improved tool, in the form of an Operational Description Template (ODT), and an integrated system comprising a plurality of such Operational Description Templates (ODTs), which effectively embodies three sub-systems, comprising a functional sub-system, a physical sub-system, and an operational sub-system, whereby task objectives or mission statements can in fact be satisfied. In addition, the integrated system, comprising the plurality of Operational Description Templates (ODTs), establishes a common framework for effectively integrating the various component specifications such that a composite system can be defined and manufactured so as to in fact be capable of performing the various behavioral or operational task objectives or mission statements.

### STATEMENT OF GOVERNMENT INTERESTS

The United States Government has a paid-up license in connection with the present invention and accordingly has the right in limited circumstances to require the patent owner to license others on reasonable terms as provided for by means of the terms of United States Government Contract Number N61331-99-D-0041 which was awarded by means of the United States Navy.

### FIELD OF THE INVENTION

The present invention relates generally to a tool, in the form of an Operational Description Template (ODT), and an integrated system comprising a plurality of such tools or Operational Description Templates (ODTs), for meeting customer task objectives or mission statements, and more particularly to a new and improved tool, in the form of an Operational Description Template (ODT), and an integrated system comprising a plurality of such tools or Operational Description Templates (ODTs), which effectively encompass, establish, or embody three sub-systems comprising a functional sub-system, a physical sub-system, and an operational sub-system, wherein, still further or even more particularly, the functional sub-system sets forth or defines the functions that will need to be implemented or accomplished in order to meet, achieve, or satisfy the task objectives or mission statements, the physical sub-system comprises the various operational components or physical architecture, comprising, for example, human, software, and hardware entities, for actually achieving, accomplishing, or implementing the various functions embodied within the functional subsystem, and the operational sub-system operatively controls or coordinates the operative interactions of the various operational components or physical architecture comprising the physical sub-system, in a time-ordered sequence, so as to in fact achieve the functions of the functional sub-system whereby the task objectives or mission statements can in fact be met, achieved, or satisfied. The integrated system, comprising the plurality of tools, defines a common framework or means for effectively integrating the various component or system specifications such that a composite system can be manufactured so as to in fact be capable of performing the various behavioral or operational tasks or procedures.

### BACKGROUND OF THE INVENTION

In connection with current systems engineering designs or methodology for meeting task objectives or mission statements, design engineers usually begin by producing component and system specifications, however, the production of such specifications does not normally encompass behavioral or operational analysis. The functionality or operability of the systems must be subsequently verified by means of suitable testing procedures, however, the behavioral or operational analysis is generally not addressed until it is time to define the test specifications. However, since the behavioral or operational analysis has not previously been integrated with respect to the component and system specifications, redesign of the component and system specifications may be necessary at this relatively late stage of the overall design and development process. Obviously, this methodology can be quite time-consuming and costly. In addition, it has also become apparent that a common framework or means for effectively integrating the various component or system specifications, such that a composite system can be manufactured so as to in fact be capable of performing the various behavioral or operational tasks or procedures, is lacking. Accordingly, it is not at all certain as to whether or not a proper or complete composite system, which is in fact capable of performing all of the various behavioral or operational tasks or procedures originally set forth in the task objectives or mission statements, has in fact been developed.

A need therefore exists in the art for a new and improved tool, and an integrated system comprising a plurality of such tools, which can effectively encompass or integrally incorporate therein behavioral or operational analysis, and in addition, comprise or establish a common framework or means for effectively integrating the various component or system specifications such that a composite system can be defined and manufactured so as to in fact be capable of performing the various behavioral or operational tasks or procedures.

### SUMMARY OF THE INVENTION

The foregoing and other objectives are achieved in accordance with the teachings and principles of the present invention through the provision of a new and improved tool, in the form of an Operational Description Template (ODT), and an integrated system comprising a plurality or multitude of such tools or Operational Description Templates (ODTs), which effectively encompasses, establishes, or embodies three sub-systems comprising a functional sub-system, a physical sub-system, and an operational sub-system. The functional sub-system sets forth or defines the functions that will need to be implemented or accomplished in order to meet, achieve, or satisfy the task objectives or mission statements, the physical sub-system comprises the various operational components or physical architecture, comprising, for example, human, software, and hardware entities, for actually achieving, accomplishing, or implementing the various functions embodied within the functional sub-system, and the operational sub-system operatively controls or coordinates the operative interactions of the various operational components or physical architecture comprising the physical sub-system, in a time-ordered sequence, so as to in fact achieve the functions of the functional sub-system whereby the task objectives or mission statements can in fact be met, achieved, or satisfied. In addition, the integrated system, comprising the plurality or multitude of such tools, comprising the Operational Description Templates (ODTs), comprises or establishes a common framework or means for effectively integrating the various component or system specifications such that a composite system can be defined and manufactured so as to in fact be capable of performing the various behavioral or operational task objectives, procedures, or mission statements.

### BRIEF DESCRIPTION OF THE DRAWINGS

Various other objects, features, and attendant advantages of the present invention will be more fully appreciated from the following detailed description when considered in connection with the accompanying drawings in which like reference characters designate like or corresponding parts throughout the several views, and wherein:

FIG. 1 is a blank spreadsheet, in MICROSOFT® EXCEL© format, disclosing the anatomy or structure of an Operational Description Template (ODT) tool which has been constructed in accordance with the principles and teachings of the present invention, and showing the operative component parts thereof, for effectively defining or establishing the functional, physical, and operational sub-systems;

FIG. 2 is a spreadsheet, in MICROSOFT® EXCEL© format, which is similar to that of FIG. 1, but which discloses, however, an Operational Description Template (ODT) tool which has actually been generated in accordance with the principles and teachings of the present invention so as to illustrate the operative interactive component parts thereof, such as, for example, the various derived requirements and interface communications, which are utilized to accomplish a particular task in furtherance of achieving the original task objective or mission statement of the customer;

FIG. 3 is a flow chart schematically illustrating the various steps involved in connection with the generation of, for example, the Operational Description Template (ODT), as illustrated within FIG. 2, and the saving of the entry contents and data embodied within or upon the Operational Description Template (ODT), as illustrated within FIG. 2, within a suitable database, such as, for example, MICROSOFT® ACCESS©;

FIG. 4 is a drawing schematically illustrating, in part, the exemplary Operational Description Template (ODT), as disclosed within FIG. 2, and an overlying list of original customer requirements, which have been previously stored within the MICROSOFT® ACCESS© database, wherein one or more original customer requirements may be linked to each derived requirement, which have been generated and entered upon the Operational Description Template (ODT), so as to demonstrate how the customer requirements have been satisfied by means of the derived requirements;

FIG. 5 is a flow chart schematically illustrating the various steps involved in connection with the tracing of the original customer requirements, which have been stored within the MICROSOFT® ACCESS© database, to the derived requirements which have been generated upon the Operational Description Template (ODT), as illustrated within FIG. 4;

FIG. 6 is a drawing schematically illustrating a plurality of spreadsheets, in MICROSOFT® EXCEL© format, comprising a plurality of Operational Description Templates (ODTs), wherein each one of the Operational Description Templates (ODTs), similar to, for example, the Operational Description Template (ODT) as illustrated within FIG. 2, represents a tool for achieving a task in furtherance of achieving the original task objective or mission statement of the customer, and wherein further, the plurality of Operational Description Templates (ODTs), taken together, effectively form the integrated system of the present invention for meeting or achieving the task objective or mission statement of the customer;

FIG. 7 is a drawing schematically illustrating how the various hardware requirements, software requirements, human interface requirements, and communication or data transmission interface requirements specifications for the plurality of Operational Description Templates (ODTs), which, taken together, effectively form the integrated system of the present invention, as well as the test procedures for each individual Operational Description Template (ODT), are derived;

FIG. 8 is a flow chart schematically illustrating the creation of the various hardware requirements, software requirements, human interface requirements, and communication or data transmission interface requirements specification files from the plurality of Operational Description Templates (ODTs) as illustrated within FIG. 7; and

FIG. 9 is a flow chart schematically illustrating the generation of the finalized or complete specification which encompasses or embeds the various hardware requirements, software requirements, human interface requirements, and communication or data transmission interface requirements specification files, from the plurality of Operational Description Templates (ODTs) as illustrated within FIGS. 7 and 8, into a MICROSOFT® WORD© format.

### DETAILED DESCRIPTION OF THE PREFERRED EMBODIMENT

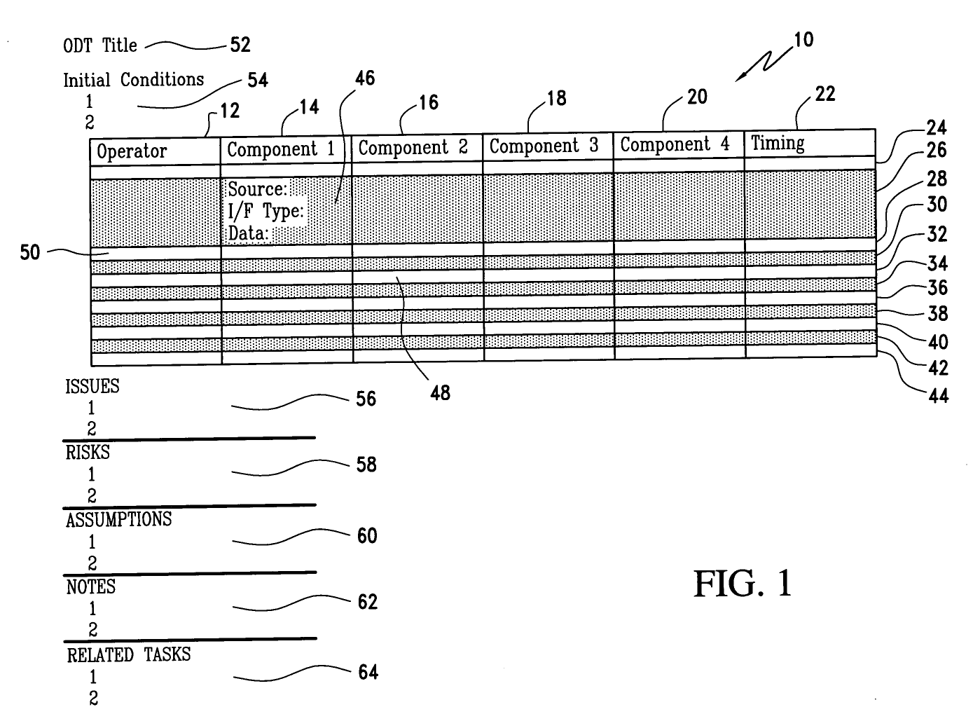

When a design engineer is initially presented with a customer task objective or mission statement, the customer task objective or mission statement will comprise a plurality of customer requirements. The design engineer, in effect, will subsequently break down the customer task objective or mission statement into a plurality or multitude of tasks which are to be performed in order to meet, achieve, or satisfy the customer requirements and, ultimately, the original customer task objective or mission statement. In accordance with the principles and teachings of the present invention, a tool has therefore been developed which effectively establishes a functional sub-system, a physical sub-system, and an operational sub-system for achieving each one of the plurality of tasks which must be performed in order to meet, achieve, or satisfy the customer requirements and, ultimately, the original customer task objective or mission statement. Referring then to the drawings, and more particularly to FIG. 1 thereof, it is seen that the aforenoted tool is in the form of an Operational Description Template (ODT) which is generally indicated by the reference character 10, and it is to be appreciated that a separate Operational Description Template (ODT) 10 embodies a single task. As can readily be appreciated still further, the Operational Description Template (ODT) tool 10 initially comprises a blank spreadsheet, in MICROSOFT® EXCEL© format, and is seen to comprise, for example, a plurality of vertically oriented columns 12,14,16,18,20,22 and a plurality of horizontally oriented rows 24,26,28,30,32,34,36,38,40,42,44, although the precise number of vertical columns and horizontal rows may of course vary. The various vertical columns 12-22 and the horizontal rows 24-44 cooperate together so as to effectively form a grid structure which defines a plurality of boxes or cells within which various entries, comprising, for example, stimuli, data interface communications, and derived requirements, can be inserted by the design engineer.

More particularly, it is seen that the first vertical column 12 is entitled OPERATOR, and that the vertical columns 14-20 are entitled COMPONENTS 1-4. In reality, in lieu of the non-descript title designations COMPONENTS 1-4, actual names of structural components would be inserted, such as, for example, COMPUTER, SONAR SYSTEM, TORPEDO, and the like. The last vertical column 22 designates the time that the design engineer has allotted or required for the performance of a particular data interface communication, for the generation of an operator stimuli, or for the generation of a derived requirement, as will be more fully appreciated hereinafter.

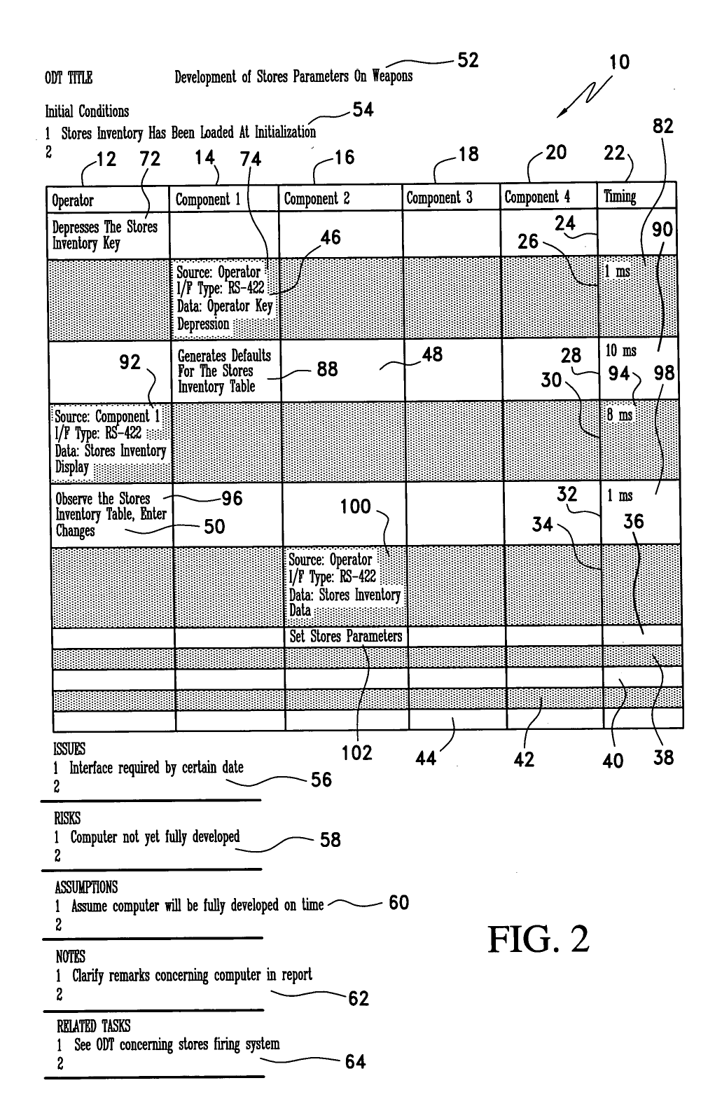

It is additionally seen that the grid structure comprises a plurality of shaded or gray-colored boxes or cells 46 within which the data interface communications are inserted or entered, and a plurality of clear or white-colored boxes or cells 48, which are positioned within the vertical columns 14-20 beneath the COMPONENTS 1-4, within which the derived requirements, respectively generated or performed by means of particular ones of the COMPONENTS 1-4, are inserted or entered. The plurality of clear or white-colored boxes or cells 50, which are positioned within the first vertical column 12 entitled OPERATOR, are adapted to have the operator stimuli inserted or entered therein, all of which will become more apparent shortly hereinafter when, for example, the specifics of FIG. 2 are discussed in detail. Lastly, in connection with the plurality of shaded or gray-colored boxes or cells 46 within which the data interface communications are inserted or entered, it is noted that such data entry is inserted in accordance with a predetermined format comprising, for example, the data heading SOURCE, next to which will be entered the source from which the data interface communication is being transmitted, the data heading I/F TYPE, next to which will be entered the particular type of data communication interface which is being used for transmitting the data, and the data heading DATA, next to which will be entered the particular data which is in fact being transmitted.

Continuing further, and with additional reference being made to FIG. 2, it is lastly to be appreciated, in connection with the format of a typical Operational Description Template (ODT) 10, that various auxiliary spaces, for accommodating data or information which is auxiliary or peripheral to the primary operator stimuli entries, the data interface communications, and the derived requirement entries which will be made and inserted into the various boxes 46-50 defined by means of the vertical columns 12-22 and the horizontal rows 24-44 of the grid structure, as has been noted hereinbefore, are also provided upon the Operational Description Template (ODT) 10. More particularly, for example, it is noted that within the uppermost region of the Operational Description Template (ODT) 10, there is provided the heading ODT TITLE, next to which there is a space 52 within which a suitably descriptive title can be inserted so as to readily identify the particular Operational Description Template (ODT) 10 which has been developed or generated so as to deal with a particular task, it being remembered that a separate Operational Description Template (ODT) 10 effectively embodies or represents a single task. As illustrated, for example, within FIG. 2, the title DEVELOPMENT OF STORES PARAMETERS ON WEAPONS has been inserted. In addition to the heading ODT TITLE, and the actual aforenoted inserted title, there is also provided a heading entitled INITIAL CONDITIONS, beneath which there are a plurality of spaces 54 within which, for example, initial or known conditions relevant to the particular task are to be noted. As illustrated within FIG. 2, for example, one of the initial conditions, that has been noted and inserted, states that THE STORES INVENTORY HAS BEEN LOADED AT INITIALIZATION. In a similar manner, beneath the aforenoted grid defined by means of the vertical columns 12-22 and horizontal rows 24-44, there is also provided a heading entitled ISSUES, beneath which there are a plurality of spaces 56 within which, for example, an issue of interest to the operator, for example, can be noted. In particular, as illustrated within FIG. 2, for example, one of the issues, that has been noted and inserted, states that the INTERFACE IS REQUIRED BY A CERTAIN DATE. Continuing further, beneath the aforenoted heading ISSUES and the spaces 56 within which the exemplary issue has been inserted, there is provided an additional heading entitled RISKS, beneath which there are a plurality of spaces 58 within which, for example, a particular risk, relevant to the particular task which is embodied within this particular Operational Description Template (ODT) 10, or which is being addressed by means of this particular Operational Description Template (ODT) 10, and upon which the risk may have a significant impact, can be noted. In particular, as illustrated within FIG. 2, for example, one of the risks, that has been noted and inserted, states that the COMPUTER IS NOT YET FULLY DEVELOPED.

Still yet further, it is noted that beneath the aforenoted heading RISKS and the spaces 58 within which the exemplary risk has been inserted, there is provided an additional heading entitled ASSUMPTIONS, beneath which there are a plurality of spaces 60 within which, for example, a particular assumption, relevant to the particular task which is embodied within this particular Operational Description Template (ODT) 10, or which is being addressed by means of this particular Operational Description Template (ODT) 10, and upon which the assumption may have a significant impact, can be noted. In particular, as illustrated within FIG. 2, for example, one of the assumptions, that has been noted and inserted, states ASSUME THE COMPUTER WILL BE FULLY DEVELOPED ON TIME. Continuing further, it is noted that beneath the aforenoted heading ASSUMPTIONS and the spaces 60 within which the exemplary assumption has been inserted, there is provided an additional heading entitled NOTES, beneath which there are a plurality of spaces 62 within which, for example, a particular note, relevant to the particular task which is embodied within this particular Operational Description Template (ODT) 10, or which is being addressed by means of this particular Operational Description Template (ODT) 10, and upon which the note may have a significant impact, can be noted. In particular, as illustrated within FIG. 2, for example, one of the notes, that has been noted and inserted, states CLARIFY THE REMARKS, CONCERNING THE COMPUTER, IN THE REPORT.

Lastly, it is noted that beneath the aforenoted heading NOTES and the spaces 62 within which the exemplary note has been inserted, there is provided an additional heading entitled RELATED TASKS, beneath which there are a plurality of spaces 64 within which, for example, a particular related task, relevant to the particular task which is embodied within this particular Operational Description Template (ODT) 10, or which is being addressed by means of this particular Operational Description Template (ODT) 10, and upon which the related task may have a significant impact, can be noted. In particular, as illustrated within FIG. 2, for example, one of the related tasks, that has been noted and inserted, states SEE ODT CONCERNING STORES FIRING SYSTEM. This is very important because it alerts the operator to the fact that the particular Operational Description Template (ODT) 10 that the operator is currently working on is related to one or more other Operational Description Templates (ODTs), or considered from an alternative point of view, one or more other Operational Description Templates (ODTs) are related to, and may have a significant impact upon the current particular Operational Description Template (ODT) 10. It is of course to be noted or appreciated that in lieu of the particular aforenoted headings and entries thereunder, such headings and entries have been noted strictly as examples, and therefore, other or additional types of headings and entries can be incorporated upon one or more of the Operational Description Templates (ODTs).

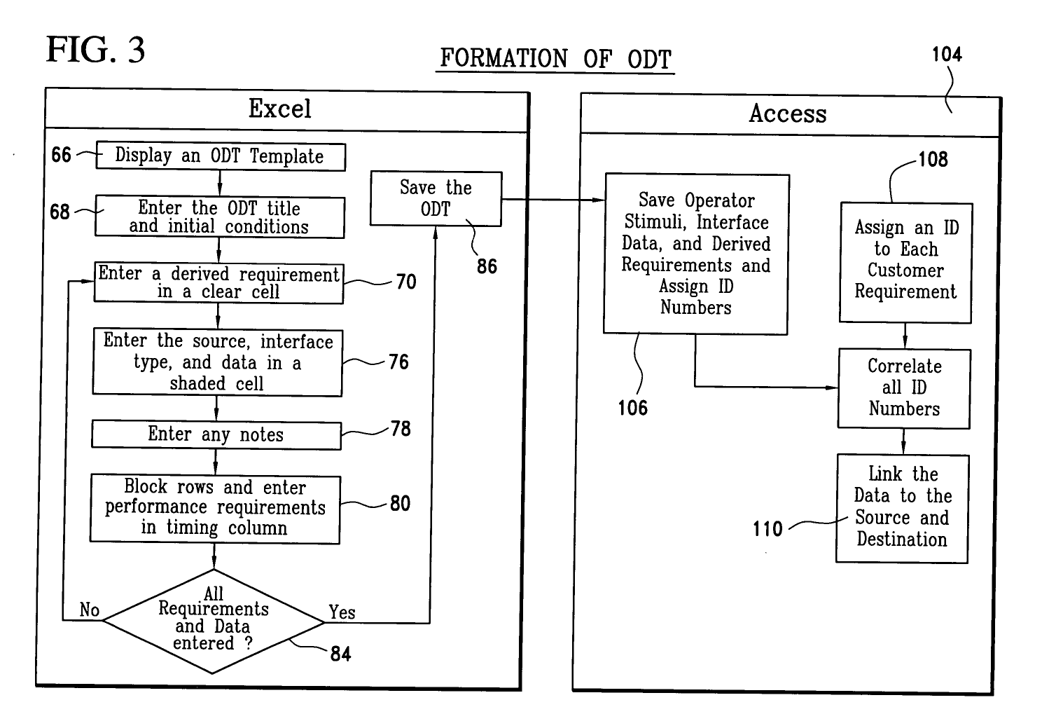

With reference now being made to FIGS. 1-3, having described the basic components and format of the Operational Description Template (ODT) 10, the procedure or methodology for generating or creating the Operational Description Template (ODT) 10, as disclosed within FIGS. 1 and 2, will now be described. More particularly, in connection with the procedure or methodology for generating or creating each Operational Description Template (ODT) 10, a blank Operational Description Template (ODT), similar to the blank Operational Description Template (ODT) 10 as disclosed within FIG. 1, is displayed at Step 66. Once the blank Operational Description Template (ODT) 10 has been displayed, the operator enters the Operational Description Template (ODT) title and initial conditions within the spaces 52,54, respectively, upon the Operational Description Template (ODT) 10, as indicated at Step 68 upon the flow chart of FIG. 3, and subsequently, the operator will proceed to enter a derived requirement or stimuli within a clear or white-colored box or cell as indicated at Step 70 upon the flow chart of FIG. 3. Since this will be the first or initial operator entry, the entry will actually comprise an operator stimuli and is entered into the first or uppermost clear or white-colored grid box or cell 72, located within column 12 and under the heading OPERATOR, of the Operational Description Template (ODT) 10 as illustrated within FIG. 2. In particular, the entry DEPRESSES THE STORES INVENTORY KEY is noted. Accordingly, in response to the entry of such operator stimuli, and in accordance with the flow chart of FIG. 3, the operator then enters the data information within the first or uppermost shaded or gray-colored grid box or cell 74 of column 14, under the heading COMPONENT 1 of the Operational Description Template (ODT) 10, in accordance with Step 76 of the flow chart of FIG. 3. More particularly, as can be appreciated from FIG. 2, the data information entered into the shaded or gray-colored grid box or cell 74 identifies the SOURCE of the data as coming from the OPERATOR, it identifies the I/F TYPE of interface data transmission as comprising an RS-422 system, and it identifies the DATA being transmitted as the OPERATOR KEY DEPRESSION.

At this point in time, as noted at Step 78 upon the flow chart of FIG. 3, the operator may enter any NOTES (as well as any ISSUES, RISKS, ASSUMPTIONS, or RELATED TASKS) into the spaces 56-64 of the Operational Description Template (ODT) 10, however, such entry into the NOTES, or any of the other auxiliary or peripheral spaces 56-64 of the Operational Description Template (ODT) 10, may be deferred until completion of all of the data entries upon the Operational Description Template (ODT) 10. It is to be appreciated, however, that an important data entry onto the Operational Description Template (ODT) 10 is in fact noted at Step 80 upon the flow chart of FIG. 3, and this comprises the assignation of the various performance requirements within timing column 22 of the Operational Description Template (ODT) 10. As noted within the first shaded or gray-colored box or cell 82 of column 22, under the heading TIMING of the Operational Description Template (ODT) 10 of FIG. 2, the performance requirement for the data transmission noted within the first shaded or gray-colored box or cell 74 of the Operational Description Template (ODT) 10 has been noted, for example, as being 1 ms.

With reference still being made to FIG. 3, after the time performance requirement has been entered into the first shaded or gray-colored box or cell 82 of the Operational Description Template (ODT) 10 in connection with the data transmission noted within the shaded or gray-colored box or cell 74 of the Operational Description Template (ODT) 10, the operator must then decide if the Operational Description Template (ODT) 10 has been completed, or is still uncompleted, in connection with the entry of all necessary data, as illustrated at Step 84 upon the flow chart of FIG. 3. If all of the necessary data has in fact been entered onto the Operational Description Template (ODT) 10 whereby the Operational Description Template (ODT) 10 has in fact been completed, and where, therefore, the answer to the inquiry is YES, then the operator will proceed to SAVE the completed Operational Description Template (ODT) 10 as denoted at Step 86 upon the flow chart of FIG. 3, however, if the answer to the inquiry concerning the completeness or incompleteness of the data appearing upon the Operational Description Template (ODT) 10, as indicated at Step 84, is NO, then the operator will proceed to effectively repeat the processing Steps 70,76,78, and 80 as noted upon the flow chart of FIG. 3.

More particularly, for example, in view of the fact that COMPONENT 1 may be, for example, a computer, it will perform an operation which the operator will note as a derived requirement or stimuli and which will therefore be entered, in accordance with Step 70 of the flow chart of FIG. 3, within the clear or white-colored box or cell 88 of the grid of the Operational Description Template (ODT) 10 which is located in column 14 under the heading COMPONENT 1 and which is directly beneath the data transmission noted within the shaded or gray-colored box or cell 74 of the Operational Description Template (ODT) 10, such entry being noted, for example, as being GENERATES DEFAULT FOR STORES IVENTORY TABLE. In conjunction with such derived requirement or stimuli entry 88, the operator also enters the time requirement or assignation, under the heading TIMING, for the computer to perform the derived requirement or stimuli 88, within the second clear or white-colored box or cell 90 of column 22 of the grid of the Operational Description Template (ODT) 10, in accordance with Step 80 of the flow chart of FIG. 3, such entry being noted, for example, as 10 ms.

Continuing further, in connection with the generation of the derived requirement or stimuli 88 by the COMPONENT 1 computer, data will be transmitted back to the operator in the form of a stores inventory display, and in accordance with the flow chart of FIG. 3, the operator then enters such data information within the second shaded or gray-colored grid box or cell 92 of column 12 of the Operational Description Template (ODT) 10, in accordance with Step 76 of the flow chart of FIG. 3. More particularly, as can be appreciated from FIG. 2, the data information entered into the second shaded or gray-colored grid box or cell 92 identifies the SOURCE of the data as coming from COMPONENT 1, it identifies the I/F TYPE of interface data transmission as comprising an RS-422 system, and it identifies the DATA being transmitted as the STORES INVENTORY DISPLAY. It is noted that this data entry is entered or inserted within the second shaded or gray-colored grid box or cell 92, located beneath the heading OPERATOR, as opposed to, for example, within the first shaded or gray-colored grid box or cell located beneath the heading OPERATOR, because the Operational Description Template (ODT) 10 represents a time-ordered sequence or continuum. Therefore, in accordance with such time-ordered sequence or continuum, the data entry within the shaded or gray-colored grid box or cell 92 must follow or be located below the derived requirement noted within the clear or white-colored grid box or cell 88. Still further, in conjunction with such data transmission entry 92, the operator also enters the time requirement or assignation for the data transmission to be completed, under the heading TIMING and within the second shaded or gray-colored box or cell 94 of column 22 of the grid of the Operational Description Template (ODT) 10, in accordance with Step 80 of the flow chart of FIG. 3, such entry being noted, for example, as being 8 ms.

Continuing yet still further, as a consequence of the data transmission from the COMPONENT 1 computer to the OPERATOR, as inserted within the second shaded or gray-colored grid box or cell 92 of the Operational Description Template (ODT) 10, which is located beneath the heading OPERATOR within the grid of the Operational Description Template (ODT) 10, the operator then inserts a stimuli within the third clear or white-colored grid box or cell 96 of column 12 of the Operational Description Template (ODT) 10, located beneath the heading OPERATOR, in accordance with Step 70 of the flow chart of FIG. 3, it again being remembered that such stimuli entry must be entered within the third clear or white-colored grid box or cell 96, located beneath the heading OPERATOR as well as below the data transmission located within the second shaded or gray-colored grid box or cell 92 of the Operational Description Template (ODT) 10, in view of the fact that the Operational Description Template (ODT) 10 represents a time-ordered sequence or continuum. As noted within the third clear or white-colored grid box or cell 96 of the Operational Description Template (ODT) 10, the operator stimuli at this point in time comprises, in effect, OBSERVING THE STORES INVENTORY TABLE AND ENTERING CHANGES. In conjunction with the entry and performance of such operator stimuli, the operator also enters the time requirement or assignation, for such operation to be completed, within column 22 under the heading TIMING and within the third clear or white-colored grid box or cell 98 of the Operational Description Template (ODT) 10, in accordance with Step 80 of the flow chart of FIG. 3, such entry being noted, for example, as being 1 ms, although it is of course to be appreciated that the particular time requirement or assignation may vary depending upon, for example, the need for the entry of data changes or the extent of such changes.

In response to the entry and performance of the stimuli operations initiated by means of the operator, as noted within the third clear or white-colored grid box or cell 96 of the Operational Description Template (ODT) 10, and in accordance with Step 76 of the flow chart of FIG. 3, the operator then enters the data information within the third shaded or gray-colored grid box or cell 100, which is located within column 16 under the heading COMPONENT 2 of the Operational Description Template (ODT) 10, which may be, for example, a weapon system. More particularly, as can be appreciated from FIG. 2, the data information entered into the third shaded or gray-colored grid box or cell 100 identifies the SOURCE of the data as coming from the OPERATOR, it identifies the I/F TYPE of interface data transmission as comprising an RS-422 system, and it identifies the DATA being transmitted as the STORES INVENTORY DATA. It is to again be appreciated that such data transmission entry is entered within the third shaded or gray-colored grid box or cell 100 of column 16 in view of the fact that the Operational Description Template (ODT) 10 represents a time-ordered sequence or continuum, and in addition, while no time requirement or assignation is actually noted within TIMING column 22, such an entry will in fact be entered in accordance with Step 80 as noted upon the flow chart of FIG. 3.

Lastly, in view of, or in response to, the data transmission noted in the grid box or cell 100, a derived requirement will be generated by COMPONENT 2, and this derived requirement will be noted, in accordance with Step 70 of the flow chart of FIG. 3, within the fourth clear or white-colored grid box or cell 102 which is located within column 16, beneath heading COMPONENT 2, and directly beneath or below the data entry contained within the third shaded or gray-colored grid box or cell 100 in order to properly formulate the aforenoted timed sequence or continuum. In particular, the derived requirement, as entered, for example, comprises SET STORES PARAMETERS, and such entry completes the generation of the Operational Description Template (ODT) 10. It is also again noted that while no time requirement or assignation is actually noted within TIMING column 22, such an entry will in fact be entered in accordance with Step 80 as noted upon the flow chart of FIG. 3. It is to be further appreciated in connection with the TIMING column 22, and the various time data entered within, for example, grid boxes or cells 82,90,94,98, that in lieu of separately noting the time performance requirements individually, as has been illustrated within the grid boxes or cells 82,90,94,98 of the Operational Description Template (ODT) 10 of FIG. 2, a section of the vertical column 22 may be alternatively blocked so as to comprise, in effect, a single vertically oriented box or cell simply indicating the overall time frame within which all of the various operator stimuli, data transmissions, and derived requirements are to be completed.

Referring again to the flow chart of FIG. 3, and in view of the fact that the Operational Description Template (ODT) 10 has now been completed, or in other words, all operator stimuli, derived requirements, and interface communication data have been entered, as is noted at Step 84 of the flow chart of FIG. 3, then the completed Operational Description Template (ODT) 10 can now in fact be saved, as noted at Step 86 of the flow chart of FIG. 3. Accordingly, still further, the various operator stimuli, derived requirement, and interface communication data entries will now be entered into a suitable memory or database, such as, for example, MICROSOFT® ACCESS© which is indicated by the reference character 104 upon the flow chart of FIG. 3. More particularly, when the completed Operational Description Template (ODT) 10 is saved in accordance with Step 86 of the flow chart, each one of the operator stimuli, interface data communications, and derived requirements which appears upon the completed Operational Description Template (ODT) 10 is assigned an identification number by means of suitable software programming incorporated within the ACCESS© database, as indicated at Step 106 of the flow chart. In addition to providing each one of operator stimuli, interface data communications, and derived requirements with their own identification numbers, it is noted that the original customer requirements, which have been previously entered into the ACCESS© database, have similarly been assigned their own identification numbers, as is indicated at Step 108. Subsequently, all of such data entries, and their associated identification numbers, are correlated, as at Step 110 of the flow chart, and still further, all of such correlated data is further linked to all sources and destinations, inherent within the interface data communications appearing upon the completed Operational Description Template (ODT) 10. In this manner, as will become more apparent immediately hereinafter, all pertinent data can be traced and accessed by means of several different inquiries or queries.

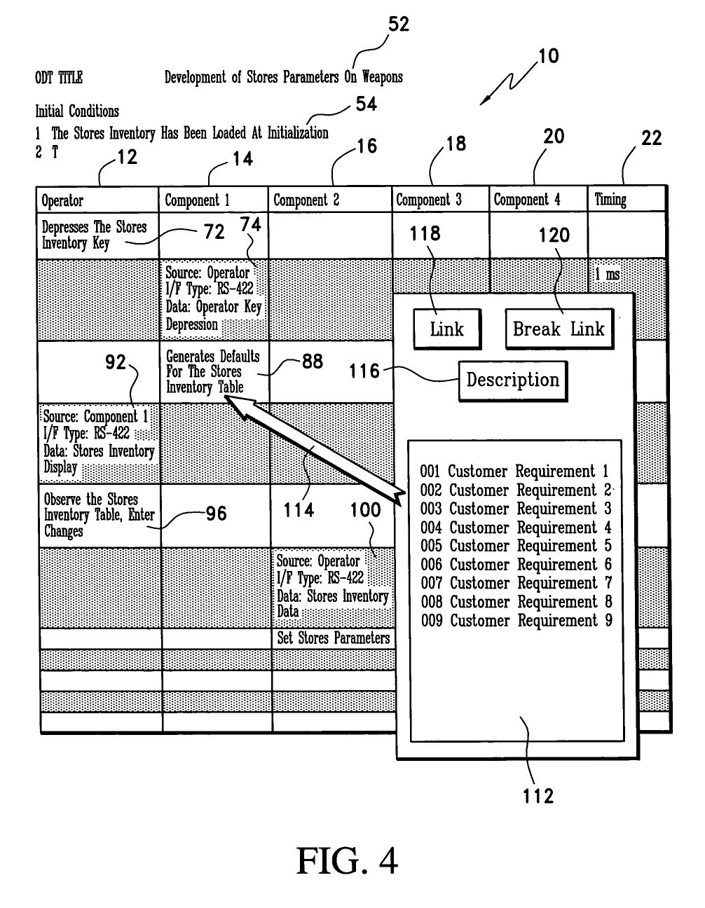

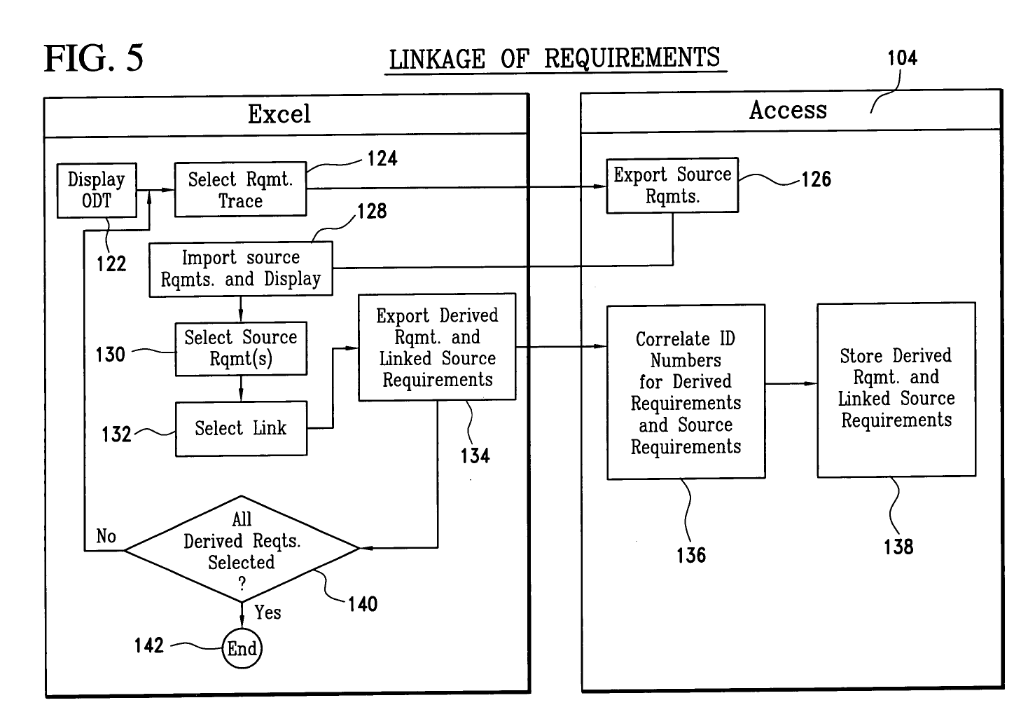

More particularly, with reference now being made to FIGS. 4 and 5, and in accordance with another unique and novel feature characteristic of the present invention, data or information links can be established between the original customer requirements and the derived requirements so as to establish direct data or information links which permit anyone to verify, for example, precisely how the original customer requirements have in fact been satisfied or met by means of the generated or derived requirements. While the complete Operational Description Template (ODT) 10 has been disclosed within FIG. 2, the same is only partially disclosed within FIG. 4. In addition, a list of original CUSTOMER REQUIREMENTS is disclosed at 112 and is generated, for example, as a pop-up screen upon the operator's main computer screen by right-clicking the computer's mouse when the computer screen cursor, operatively associated with the mouse, is positioned, for example, over any one of the clear or white-colored grid boxes or cells, such as for example, clear or white-colored grid box or cell 88 as is schematically illustrated by means of the arrow 114. The CUSTOMER REQUIREMENTS are listed, for example, as CUSTOMER REQUIREMENTS 1-9, and each CUSTOMER REQUIREMENT will appear in the form of a customer requirement title. In order to retrieve a full or complete description of the particular CUSTOMER REQUIREMENT, the operator can use the computer mouse to click on the box marked DESCRIPTION which is disclosed at 116 and which is integrally incorporated within the pop-up screen containing the list of CUSTOMER REQUIREMENTS 112. The pop-up screen containing the list of CUSTOMER REQUIREMENTS 112 is further provided with two other boxes entitled LINK and BREAK LINK, as respectively denoted at 118,120, the purposes of which will now be discussed in connection with the linking together of the CUSTOMER REQUIREMENTS and particular ones of the derived requirements which have been previously entered into the various clear or white-colored grid boxes or cells present upon the completed Operational Description Template (ODT) 10.

With reference therefore now being made to FIG. 5, a completed Operational Description Template (ODT), such as, for example, the Operational Description Template (ODT) 10 as disclosed within FIGS. 2 and 4, is displayed as disclosed at Step 122 within the flow chart of FIG. 5. A particular derived requirement, appearing within any one of the clear or white-colored grid boxes or cells upon the displayed Operational Description Template (ODT) 10, is then selected, by right-clicking upon the same as has been previously schematically indicated by means of the arrow 114 within FIG. 4 in connection with the derived requirement present within the grid box or cell 88, and such method step is illustrated at Step 124 within the flow chart of FIG. 5. As a result of the selection of the particular derived requirement, a command is transmitted to the ACCESS© database 104, and in response to such command, the ACCESS© database 104 will export the list of source requirements or CUSTOMER REQUIREMENTS 112, as noted at Step 126 of the flow chart of FIG. 5, such that the list of source requirements or CUSTOMER REQUIREMENTS 112 can be displayed as noted at Step 128 upon the flow chart of FIG. 5. At this point in time, one or more source requirements or CUSTOMER REQUIREMENTS is selected from the list of CUSTOMER REQUIREMENTS 112, as noted at Step 130 of the flow chart of FIG. 5, and subsequently, as disclosed at Step 132 of the flow chart of FIG. 5, the operator clicks on the LINK box 118 of the CUSTOMER REQUIREMENT pop-up screen as disclosed within FIG. 4.

This process therefore establishes an informational or data link between the selected derived requirement present within the grid box or cell 88 of the displayed Operational Description Template (ODT) 10 and the one or more source requirements or CUSTOMER REQUIREMENTS selected from the list of CUSTOMER REQUIREMENTS 112. Accordingly, as disclosed at Step 134 of the flow chart of FIG. 5, the linked derived requirement and the one or more source requirements or CUSTOMER REQUIREMENTS are exported to the ACCESS© database 104 whereby the identification numbers, identifying the particular derived requirement and the one or more source requirements or CUSTOMER REQUIREMENTS, are correlated, as noted at Step 136 of the flow chart of FIG. 5, so as to in fact establish the aforenoted links between the particular derived requirement and the one or more source requirements or CUSTOMER REQUIREMENTS. Subsequently, as disclosed at Step 138 of the flow chart of FIG. 5, the linked derived requirement and source requirements or CUSTOMER REQUIREMENTS are stored within the ACCESS© database 104. Lastly, once a particular derived requirement and its associated source requirements or CUSTOMER REQUIREMENTS have been selected, linked, and stored within the ACCESS© database 104, it is seen, as noted at Step 140 of the flow chart of FIG. 5, that if all of the derived requirements have not as yet been selected and linked with their associated source requirements or CUSTOMER REQUIREMENTS, that is, the answer to the processing inquiry ALL DERIVED REQUIREMENTS SELECTED is NO, then processing Steps 124-138 are effectively repeated. To the contrary, if the answer to the processing inquiry ALL DERIVED REQUIREMENTS SELECTED is YES, then the derived requirement and source requirement linkage procedure is ended as noted at Step 142 of the flow chart of FIG. 5 which is marked END. It is of course to be understood that if, for some reason, a link between a particular derived requirement and one or more of the source requirements or CUSTOMER REQUIREMENTS is to be broken, disestablished, or no longer be maintained, similar processing can be implemented by means of the operator clicking upon the BREAK LINK box 120 of the CUSTOMER REQUIREMENT pop-up screen as disclosed within FIG. 4.

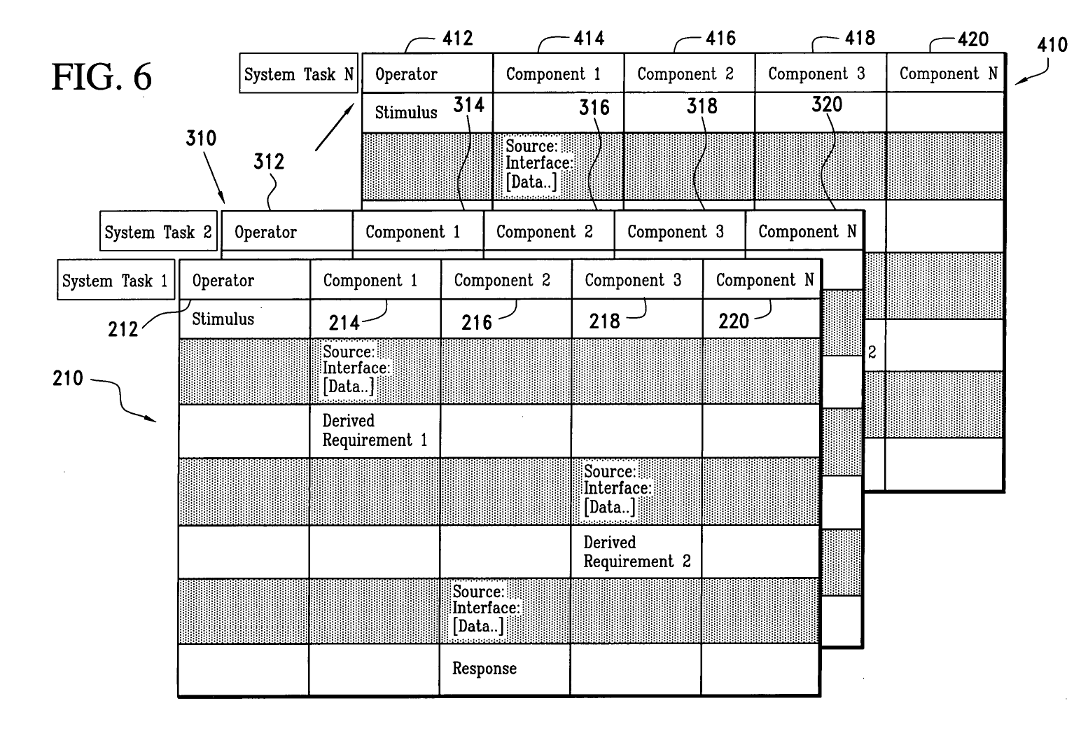

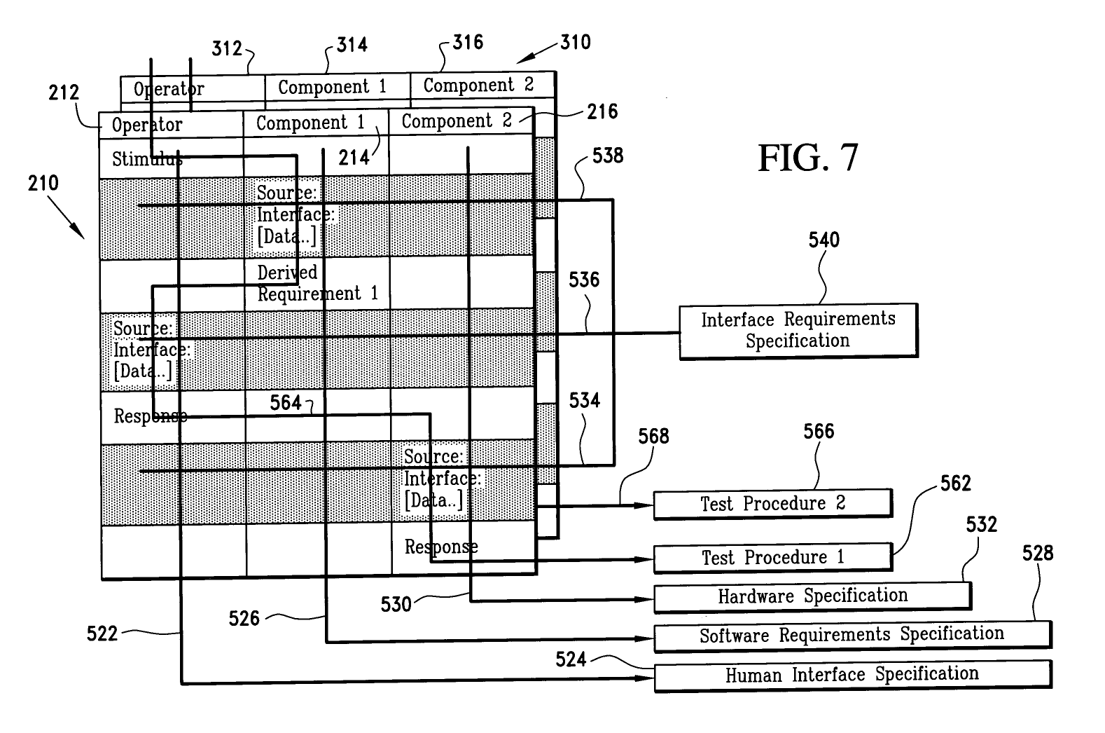

With reference now being made to FIGS. 6 and 7, and in accordance with yet another unique and novel feature characteristic of the present invention, it is seen that a plurality of Operational Description Templates (ODTs) are disclosed and are generally indicated by reference characters 210,310,410. The illustrated Operational Description Templates (ODTS) 210,310,410 are blank Operational Description Templates (ODTs), however, for the purposes of the present discussion, it is assumed that the Operational Description Templates (ODTs) 210,310,410 do in fact comprise completed Operational Description Templates (ODTs). Accordingly, all of the Operational Description Templates (ODTs) 210, 310,410 respectively comprise OPERATOR columns 212,312,412, COMPONENT 1 columns 214,314,414, COMPONENT 2 columns 216, 316,416, COMPONENT 3 columns 218,318,418, and COMPONENT N columns 220,320,420, it being appreciated that each one of the Operational Description Templates (ODTs) 210,310,410 has incorporated thereon as many component columns as is necessary to perform the particular task for which the particular one of the Operational Description Templates (ODTs) 210,310, 410 has been created. In addition, as has been noted hereinbefore, it is also to be appreciated and recalled that in lieu of the non-descript title designations COMPONENTS 1-N, actual names of structural components, such as, for example, COMPUTER, SONAR SYSTEM, TORPEDO, and the like, would be inserted upon the Operational Description Templates (ODTS) 210,310,410.

Still further, it is also to be appreciated that each one of the COMPONENTS 1-N noted upon each one of the Operational Description Templates (ODTs) 210,310,410 represents, designates, or comprises the same particular structural component, that is, COMPONENT 1 is always, for example, a COMPUTER, COMPONENT 2 is always, for example, a SONAR SYSTEM, COMPONENT 3 is always, for example, a TORPEDO, and the like. Therefore, regardless of which one of the Operational Description Templates (ODTs) is being displayed or accessed, the COMPONENT 1/COMPUTER appearing upon a particular one of the Operational Description Templates (ODTs) 210, 310,410 is the same as the COMPONENT 1/COMPUTER appearing upon one or more of the other Operational Description Templates (ODTs) 210,310,410. More specifically, if COMPONENT 1 is in fact a COMPUTER, then the COMPONENT 1 or COMPUTER listed upon Operational Description Template (ODT) 210 is the same COMPONENT 1 or COMPUTER listed upon the Operational Description Templates (ODTs) 310 and 410.

The aforenoted arrangement or formatting of the plurality of Operational Description Templates (ODTs) 210, 310,410 is critically significant because it permits all of the various structural components of the plurality of Operational Description Templates (ODTs) 210,310,410 to be correlated and integrated together whereby composite specifications of such structural components can effectively be formulated so as to enable the construction or fabrication of the various structural components which will in fact be capable of performing all of the necessary tasks in order to satisfy the customer requirements and the overall customer objective or mission statement. For example, as schematically illustrated within FIG. 7, which notably only illustrates Operational Description Templates (ODTs) 210 and 310, but which schematically can encompass N number of Operational Description Templates (ODTs) as illustrated within FIG. 6, if all of the derived requirement data or information, disposed within the clear or white-colored grid boxes or cells concerning the OPERATOR were to be gathered, collected, collated, correlated, or integrated together from all of the separate Operational Description Templates (ODTs) 210, 310,410, as schematically indicated by means of line or flow path 522, a composite HUMAN INTERFACE SPECIFICATION 524 would be able to be effectively created. In this manner, for example, a proper or suitable OPERATOR or HUMAN INTERFACE, in the form of, for example, system controls, system displays, and the like, could be created in order to play its vital role in performing all of the necessary tasks so as to ultimately satisfy the customer requirements and the overall customer objective or mission statement. In a similar manner, if all of the derived requirement data or information, disposed within the clear or white-colored grid boxes or cells concerning COMPONENT 1 were to be gathered, collected, collated, correlated, or integrated together from all of the separate Operational Description Templates (ODTs) 210,310, 410, as schematically indicated by means of line or flow path 526, a composite COMPONENT 1 SPECIFICATION, which may be, for example, SOFTWARE REQUIREMENTS SPECIFICATION 528 would be able to effectively be created. In this manner, for example, proper or suitable SOFTWARE REQUIREMENTS, in the form of, for example, software, programs, and the like, could be created in order to play its vital role in performing all of the necessary tasks so as to ultimately satisfy the customer requirements and the overall customer objective or mission statement.

Still yet further, if all of the derived requirement data or information, disposed within the clear or white colored grid boxes or cells concerning COMPONENT 2 were to be gathered, collected, collated, correlated, or integrated together from all of the separate Operational Description Templates (ODTS) 210,310,410, as schematically indicated by means of line or flow path 530, a composite COMPONENT 2 SPECIFICATION, which may be, for example, HARDWARE SPECIFICATION 532, would effectively be able to be created. In this manner, for example, proper or suitable HARDWARE, in the form of, for example, memory chips, disk drives, and the like, could be created in order to play its vital role in per-forming all of the necessary tasks so as to ultimately satisfy the customer requirements and the overall customer objective or mission statement. It is to be appreciated that while the particular generated specifications, other than the HUMAN INTERFACE SPECIFICATION 524, have been denoted as the SOFTWARE REQUIREMENTS SPECIFICATION 528 and the HARDWARE SPECIFICATION 532, these specifications are only exemplary and are only reflective of the particular structure comprising, for example, COMPONENTS 1 and 2. If, for example, COMPONENTS 1 and 2 were in fact a COMPUTER and a SONAR SYSTEM, as has been noted hereinbefore, then the particular specification to be generated from such COMPUTER and SONAR SYSTEM components may be different than a SOFTWARE REQUIREMENTS SPECIFICATION and a HARDWARE SPECIFICATION.

The critical feature of the present invention that is to be appreciated here is that regardless of what the particular COMPONENT 1 or COMPONENT 2 is, a composite specification may be derived or generated as a result of the collation, correlation, or integration together of the various derived requirement data and information concerning such COMPONENT 1 or COMPONENT 2 from all of the separate Operational Description Templates (ODTs) 210,310,410. Lastly, in a yet similar manner, if all of the data or information concerning the interface data communications, which have been entered within the shaded or gray-colored grid boxes or cells upon the different Operational Description Templates (ODTs) 210,310,410, were to be gathered, collected, collated, correlated, or integrated together from all of the separate Operational Description Templates (ODTs) 210,310,410, as schematically indicated by means of the lines or flow paths 534,536,538, a composite INTERFACE REQUIREMENTS SPECIFICATION 540 would be able to effectively be created. In this manner, an operational sub-system, operatively interconnecting or “wiring together” the various operational components or physical architecture, which comprises the physical sub-system for achieving the various functions of the functional sub-system, can in fact be met, achieved, or satisfied in a time-sequenced manner so as to ultimately satisfy the customer requirements and the overall customer objective or mission statement.

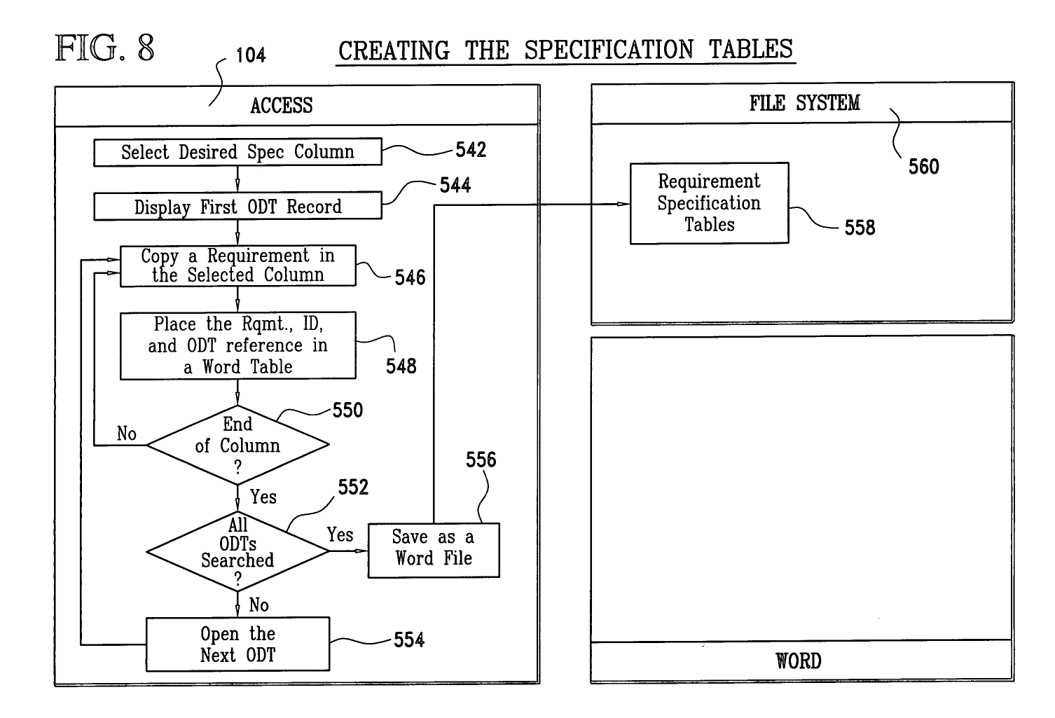

With reference therefore now being made to FIG. 8, and having previously described the inherent relationship existing between each one of the particular components which may commonly exist or appear upon one or more of the various Operational Description Templates (ODTs) 210,310,410, and in addition, having previously described the intended formulation, creation, or generation of the various HUMAN INTERFACE, SOFTWARE REQUIREMENTS, HARDWARE, and INTERFACE REQUIREMENTS SPECIFICATIONS 524,528,532,540, the procedure or methodology for actually formulating, creating, or generating such HUMAN INTERFACE, SOFTWARE REQUIREMENTS, HARDWARE, and INTERFACE REQUIREMENTS SPECIFICATIONS 524,528,532,540 will now be described. More particularly, in connection with the procedure or methodology for formulating, creating, or generating such HUMAN INTERFACE, SOFTWARE REQUIREMENTS, HARDWARE, and INTERFACE REQUIREMENTS SPECIFICATIONS 524,528,532, 540, a SPECIFICATION GENERATION MODE, comprising, for example, a list of the names of the heading COMPONENTS 1-N present upon the various Operational Description Templates (ODTs) 210,310,410, that is, the names which represent the vertical OPERATOR column and the vertical COMPONENT 1-N columns, as well as a list entry designating the horizontal rows comprising the interface data communications, can be selected from a menu as a result of, for example, right-clicking upon the operator's computer mouse. The list of the vertical column names and the horizontal row interface data communication will of course be retrieved from the aforenoted ACCESS© database, and from the list of such vertical column names and horizontal row interface data communication, a particular column, such as, for example, the COMPUTER column, can be selected as denoted by means of Step 542 disposed upon the flow chart of FIG. 8. In other words, the selection of the particular COMPUTER column, for example, effectively tells the system which column or COMPONENT we are searching for upon all of the Operational Description Templates (ODTs) 210,310,410.

Subsequently, therefore, all of the Operational Description Templates (ODTs) 210,310,410 are searched, and the first one of the Operational Description Templates (ODTs) 210,310,410 which has the selected COMPONENT, such as, for example, COMPUTER, as one of its columns or COMPONENTS, is displayed. It is to be remembered that not all COMPONENTS are present upon all of the Operational Description Templates (ODTs) 210,310,410. Once the first one of the Operational Description Templates (ODTs) 210,310,410, upon which the particular COMPONENT column is present, is found, that particular Operational Description Template (ODT) is displayed, as denoted by means of Step 544 disposed upon the flow chart of FIG. 8, and the first one of the derived requirements appearing within the selected COMPONENT column is then copied, as denoted by means of Step 546 disposed upon the flow chart of FIG. 8. The copied derived requirement, along with its identification number which had been previously assigned to the derived requirement when the derived requirement was originally placed within the ACCESS© database as noted at Step 106 of the flow chart of FIG. 3, is then inserted into a MICROSOFT® WORD© table along with a reference number identifying the particular Operational Description Template (ODT) from which the derived requirement was copied, all as denoted by means of Step 548 disposed upon the flow chart of FIG. 8.

Continuing further, after the particular derived requirement has been inserted into the MICROSOFT® WORD© table as denoted by means of Step 548 disposed upon the flow chart of FIG. 8, a determination is made, as denoted by means of Step 550 of the flow chart of FIG. 8, as to whether or not the end of the particular COMPONENT or COMPUTER column, for example, has been reached. If the answer to the inquiry or query is NO, then flow chart Steps 546,548 are repeated until the end of the particular COMPONENT or COMPUTER column has in fact been reached. If the answer to the inquiry or query at Step 550 of the flow chart of FIG. 8 is YES, then the methodology or process proceeds to Step 552 of the flow chart of FIG. 8 at which another inquiry or query is effectively made as to whether or not all of the Operational Description Templates (ODTs) 210,310,410 have been searched. If the answer to the inquiry or query, as to whether or not all of the Operational Description Templates (ODTs) 210,310,410 have been searched, is NO, then the next Operational Description Template (ODT), upon which the particular COMPONENT or COMPUTER column appears, is opened or displayed as denoted at Step 554 of the flow chart of FIG. 8, and subsequently, Steps 546-552 are repeated. To the contrary, if the answer to the inquiry or query, as to whether or not all of the Operational Description Templates (ODTs) 210,310,410 have been searched, is YES, then the particular OPERATOR or COMPONENT SPECIFICATION file is complete, it is then saved as a WORD© file, as denoted by means of Step 556 of the flow chart of FIG. 8, and subsequently, the particular OPERATOR or COMPONENT SPECIFICATION WORD© file is, in turn, saved as one component of a set of requirement specification tables, as denoted at Step 558 of the flow chart of FIG. 8, which itself is stored within a FILE SYSTEM 560 or hard drive of a computer. The entire process may then of course be repeated in connection with another COMPONENT column, starting at Step 542, whereby, eventually, all of the COMPONENT SPECIFICATION WORD© files are saved within and comprise the set of requirement specification tables as at Step 558 of the flow chart of FIG. 8.

Reverting back momentarily to FIG. 7, it is to be further appreciated that, as was the case with the generation or creation of the various HUMAN INTERFACE, SOFTWARE REQUIREMENTS, HARDWARE, and INTERFACE REQUIREMENTS SPECIFICATIONS 524,528,532,540, a TEST PROCEDURE GENERATION MODE, comprising, for example, a list of TEST PROCEDURES to be separately conducted in connection with each one of the Operational Description Templates (ODTs) 210,310,410, can likewise be selected from the menu as a result of, for example, right-clicking upon the operator's computer mouse. The purpose of the TEST PROCEDURES is to ensure that the overall system as embodied within each one of the Operational Description Templates (ODTs) 210,310,410 of the present invention is viable. More particularly, the TEST PROCEDURES ensure that the various operational components, or physical architecture, comprising the physical sub-system of a particular one of the Operational Description Templates (ODTs) 210,310,410, operatively interact with each other in accordance with the desired time-ordered sequence comprising the operational sub-system of the particular one of the Operational Description Templates (ODTs) 210,310,410 so as to in fact achieve the various operative functions comprising the functional sub-system of the particular one of the Operational Description Templates (ODTs) 210,310,410.

Accordingly, when, for example, TEST PROCEDURE 1, as denoted at 562 in FIG. 7, is selected from the aforenoted menu, wherein it is to be appreciated that TEST PROCEDURE 1 is only concerned with the overall system embodied within Operational Description Template (ODT) 210, an operational test procedure will be conducted as schematically illustrated by means of the substantially sinusoidal-shaped line 564. Similar test procedures can likewise be conducted by selecting TEST PROCEDURE 2, as noted by means of the reference character 566, wherein a suitable test procedure will be conducted in connection with the overall system embodied within Operational Description Template (ODT) 310, the operational test procedure being schematically illustrated by means of the line 568. Other TEST PROCEDURES N can of course be conducted respectively in connection with as many Operational Description Templates (ODT) N as have been created in accordance with the principles and teachings of the present invention.

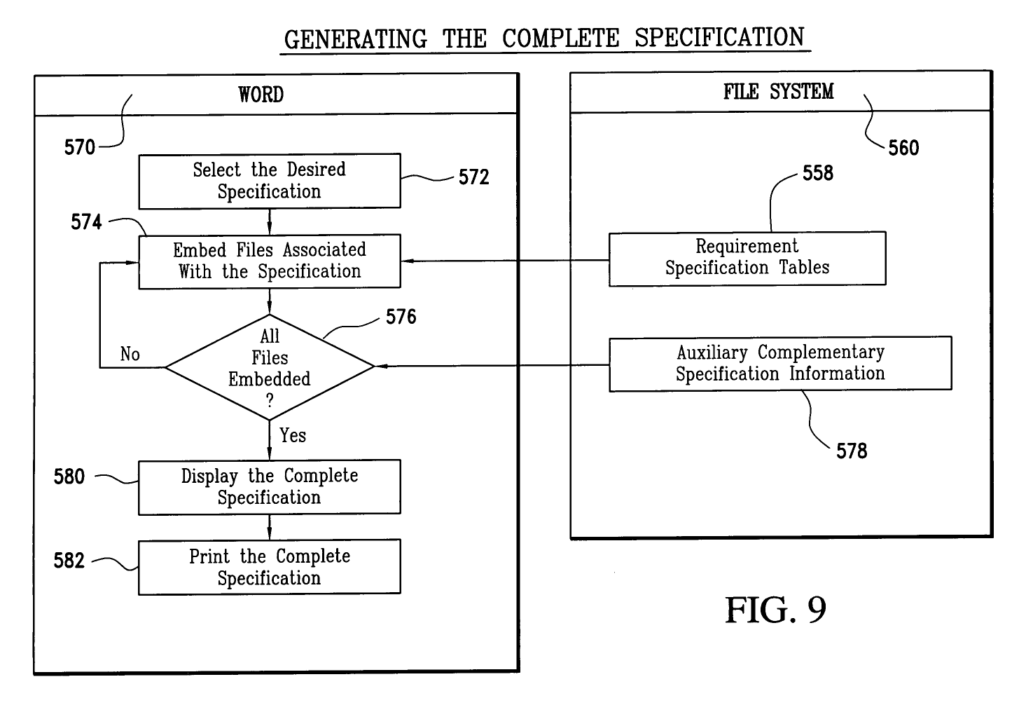

Continuing further, it is noted that once the derived requirement and interface requirements SPECIFICATIONS 524,528,532,540 have been created, saved, and formed into the REQUIREMENT SPECIFICATION TABLES 558, COMPLETE SPECIFICATIONS must lastly be generated. Each one of the COMPLETE SPECIFICATIONS will include the particular one of the derived requirement and interface requirements SPECIFICATIONS 524,528,532,540 along with other pertinent specification information or data which complements the information and data which has already been incorporated within the particular one of the derived requirement and interface requirements SPECIFICATIONS 524,528,532,540. Accordingly, as can therefore be appreciated as a result of reference being made to FIG. 9, in order to formulate or generate a particular one of the COMPLETE SPECIFICATIONS, MICROSOFT® WORD© 570 is opened and the particular COMPLETE SPECIFICATION to be formed or generated is selected or decided upon, as is illustrated at Step 572 of the flow chart of FIG. 9, by effectively entitling the WORD© document accordingly. Subsequently, the particular REQUIREMENT SPECIFICATION TABLE, dealing with the particular SPECIFICATION selected at Step 572 of the flow chart of FIG. 9, is retrieved from the REQUIREMENT SPECIFICATION TABLES 558 and embedded within the WORD© document as denoted at Step 574 of the flow chart of FIG. 9. As has been noted hereinbefore, in addition to the information or data comprising or forming each one of the REQUIREMENT SPECIFICATION TABLES 558, other complementary or auxiliary information or data may also be pertinent to the formation of each one of the COMPLETE SPECIFICATIONS.

Such auxiliary or peripheral information or data may comprise, for example, the aforenoted CUSTOMER REQUIREMENTS, background information, mission statement objectives, and the like, and may likewise be stored, for example, within the FILE SYSTEM 560. Accordingly, subsequent to the embedding of the particular REQUIREMENT SPECIFICATION TABLE within the WORD© document 572, as illustrated by means of Step 574 of the flow chart of FIG. 9, an inquiry or query is asked, at Step 576 of the flow chart of FIG. 9, to the effect of whether or not all files have been embedded within the WORD© document 572, that is, whether or not, for example, the AUXILIARY COMPLEMENTARY SPECIFICATION INFORMATION 578, pertinent to the particular REQUIREMENT SPECIFICATION TABLE, has been embedded within the WORD© document 572. If the answer to the query or inquiry is NO, then the AUXILIARY COMPLEMENTARY SPECIFICATION INFORMATION 578 is effectively retrieved from the FILE SYSTEM 560 and is embedded within the WORD© document 572 as illustrated at Step 574 of the flow chart of FIG. 9. On the other hand, if the answer to the inquiry or query is YES, then the COMPLETE SPECIFICATION has in effect been formulated or generated, and accordingly, the COMPLETE SPECIFICATION may then be displayed as illustrated at Step 580 of the flow chart of FIG. 9, and still further, a printed copy of the COMPLETE SPECIFICATION may be generated as illustrated at Step 582 of the flow chart of FIG. 9. It is, of course, to be appreciated that the various processing steps 572,574,576,580,582 may be repeated so as to generate the other COMPLETE SPECIFICATIONS which will respectively have the other particular REQUIREMENT SPECIFICATION TABLES incorporated therein.

Thus, it may be seen that in accordance with the principles and teachings of the present invention, there has been developed a new and improved tool, in the form of an Operational Description Template (ODT), and an integrated system comprising a plurality of such tools or Operational Description Templates (ODTs), which effectively embodies three sub-systems comprising a functional sub-system, a physical sub-system, and an operational sub-system. The functional sub-system sets forth or defines the functions that will need to be implemented in order to meet the task objectives or mission statements, the physical sub-system comprises the various operational components or physical architecture, comprising, for example, human, software, and hardware entities, for actually implementing the various functions embodied within the functional sub-system, and the operational sub-system operatively controls or coordinates the operative interactions of the various operational components or physical architecture comprising the physical sub-system, in a time-ordered sequence, so as to in fact achieve the functions of the functional sub-system whereby the task objectives or mission statements can in fact be satisfied. In addition, the integrated system, comprising the plurality or multitude of such tools, comprising the Operational Description Templates (ODTs), establishes a common framework or means for effectively integrating the various component or system specifications such that a composite system can be defined and manufactured so as to in fact be capable of performing the various behavioral or operational task objectives, procedures, or mission statements.

In light of the foregoing disclosure, it is noted that many variations and modifications of the present invention are possible. It is therefore to be understood that within the scope of the appended claims, the present invention may be practiced otherwise than as specifically described herein.

What is claimed as new and desired to be protected by Letters Patent of the United States of America, is:

1. A tool for defining a system for satisfying a task objective, comprising:
a functional sub-system for defining the functions that will need to be implemented in order to satisfy said task objective;
a physical sub-system comprising a plurality of operational components for implementing said functions in order to satisfy said task objective; and
an operational sub-system for operatively controlling said operational components in a time-ordered sequence so as to perform said functions of said functional sub-system whereby said task objective will be satisfied.

2. The tool as set forth in claim 1, wherein:
said tool comprises a spreadsheet defining a grid structure comprising a plurality of vertically oriented columns and a plurality of horizontally oriented rows which intersect said plurality of vertically oriented columns so as to define, along with said plurality of vertically oriented columns, a plurality of grid cells.

3. The tool as set forth in claim 2, wherein:
said plurality of vertically oriented columns identify said plurality of operational components of said physical sub-system; and
said plurality of grid cells comprise a first set of grid cells within which derived requirement functions of said functional sub-system are disposed, and a second set of grid cells within which data interface communications are disposed;
said first and second sets of grid cells being disposed within said time-ordered sequence so as to define said operational sub-system.

4. The tool as set forth in claim 3, wherein:
all of said first set of grid cells, within which said derived requirement functions of said functional subsystem are disposed, and which are arranged within a particular one of said plurality of vertically oriented columns, together comprise a specification which defines a particular one of said operational components to be manufactured.

5. The tool as set forth in claim 3, wherein:
all of said second set of grid cells, within which said data interface communications are disposed, together comprise a specification which defines how said plurality of operational components operatively interact with each other.

6. An integrated system for satisfying an overall task objective comprising a plurality of customer requirements, comprising:
a plurality of tools wherein each one of said plurality of tools is adapted to satisfy a particular operational task; and
means for operatively connecting said plurality of tools together;
each one of said plurality of tools comprising a functional sub-system for defining the functions that will need to be implemented in order to satisfy said particular operational task; a physical sub-system comprising a plurality of operational components for implementing said functions in order to satisfy said particular operational task; and an operational sub-system for operatively controlling said operational components in a time-ordered sequence so as to perform said functions of said functional sub-system whereby said customer requirements of said overall task objective will be satisfied.

7. The system as set forth in claim 6, wherein:
each one of said plurality of tools comprises a spreadsheet defining a grid structure comprising a plurality of vertically oriented columns and a plurality of horizontally oriented rows which intersect said plurality of vertically oriented columns so as to define, along with said plurality of vertically oriented columns, a plurality of grid cells.

8. The system as set forth in claim 7, wherein:
said plurality of vertically oriented columns of each one of said plurality of tools identify said plurality of operational components of said physical sub-system; and
said plurality of grid cells of each one of said plurality of tools comprise a first set of grid cells within which derived requirement functions of said functional subsystem are disposed, and a second set of grid cells within which data interface communications are disposed;
said first and second sets of grid cells being disposed within said time-ordered sequence so as to define said operational sub-system.

9. The system as set forth in claim 8, wherein:
all of said first set of grid cells of each one of said plurality of tools, within which said derived requirement functions of said functional sub-system are disposed, and which are arranged within a particular one of said plurality of vertically oriented columns, together comprise a specification which defines a particular one of said operational components to be manufactured.

10. The system as set forth in claim 8, wherein:
all of said second set of grid cells of each one of said plurality of tools, within which said data interface communications are disposed, together comprise a specification which defines how said plurality of operational components operatively interact with each other.

11. The system as set forth in claim 8, further comprising:
means for correlating together all of said first set of grid cells of all of said plurality of tools, within which said derived requirement functions of said functional sub-system are disposed, and which are arranged within a particular one of said plurality of vertically oriented columns, so as to comprise a specification which defines a particular one of said operational components to be manufactured.

12. The system as set forth in claim 8, further comprising:
means for correlating together all of said second set of grid cells of all one of said plurality of tools, within which said data interface communications are disposed, so as to comprise a specification which defines how said plurality of operational components operatively interact with each other.

13. The system as set forth in claim 8, wherein:
said means for operatively connecting said plurality of tools together comprises a database.

14. The system as set forth in claim 13, further comprising:
means for storing said plurality customer requirements within said database.

15. The system as set forth in claim 14, further comprising:
means for linking at least one of said plurality of customer requirements to any particular one of said derived requirement functions so as to verify which particular one of said derived requirement functions is being used to satisfy said at least one of said plurality of customer requirements.

16. A method for satisfying an overall task objective comprising a plurality of customer requirements, comprising the steps of:
forming a plurality of tools, wherein each one of said plurality of tools is adapted to satisfy a particular operational task, and wherein each one of said plurality of tools comprises a functional sub-system for defining the functions that will need to be implemented in order to satisfy said particular operational task; a physical sub-system comprising a plurality of operational components for implementing said functions in order to satisfy said particular operational task; and an operational sub-system for operatively controlling said operational components in a time-ordered sequence so as to perform said functions of said functional sub-system whereby said customer requirements of said overall task objective will be satisfied; and
operatively connecting said plurality of tools together.

17. The method as set forth in claim 16, further comprising the step of:
forming each one of said plurality of tools as a spreadsheet which defines a grid structure comprising a plurality of vertically oriented columns and a plurality of horizontally oriented rows which intersect said plurality of vertically oriented columns so as to define, along with said plurality of vertically oriented columns, a plurality of grid cells.

18. The method as set forth in claim 17, further comprising the steps of:
using said plurality of vertically oriented columns of each one of said plurality of tools to identify said plurality of operational components of said physical subsystem; and
using said plurality of grid cells of each one of said plurality of tools to comprise a first set of grid cells within which derived requirement functions of said functional sub-system are disposed, and a second set of grid cells within which data interface communications are disposed; and
arranging said first and second sets of grid cells within said time-ordered sequence so as to define said operational sub-system.

19. The method as set forth in claim 18, further comprising the step of:
correlating together all of said first set of grid cells of all of said plurality of tools, within which said derived requirement functions of said functional sub-system are disposed, and which are arranged within a particular one of said plurality of vertically oriented columns, so as to comprise a specification which defines a particular one of said operational components.

20. The method as set forth in claim 18, further comprising the step of:
correlating together all of said second set of grid cells of all of said plurality of tools, within which said data interface communications are disposed, and which are arranged throughout said plurality of vertically oriented columns, so as to comprise a specification which defines how said plurality of operational components operatively interact with each other.

21. The method as set forth in claim 18, further comprising the step of:
correlating together all of said first and second set of grid cells of a particular one of said plurality of tools, within which said derived requirement functions of said functional sub-system and said data interface communications are respectively disposed, so as to generate a test procedure for ensuring that said plurality of operational components of said particular one of said plurality of tools properly interact with each other in accordance with said time-ordered sequence comprising said operational sub-system of said particular one of said tools so as to in fact achieve said functions comprising said functional sub-system of said particular one of said tools.

22. The method as set forth in claim 18, further comprising the steps of:
storing said derived requirement functions within a database;
storing said plurality of customer requirements within said database; and
linking at least one of said plurality of customer requirements to any particular one of said derived requirement functions so as to verify which particular one of said derived requirement functions is being used to satisfy said at least one of said plurality of customer requirements.
